(19) United States
(12) Patent Application Publication
(10) Pub. No.: US 2017/0008777 A1
(43) Pub. Date: Jan. 12, 2017

(54) ADAPTER FOR CONNECTING AT LEAST TWO PLASTIC BOTTLES

(71) Applicant: Michael BABELUK, Wien (AT)

(72) Inventors: Daniel Kerschgens, Wien (AT); Heinz Georg Russwurm, Wien (AT)

(21) Appl. No.: 15/119,281

(22) PCT Filed: Feb. 17, 2015
(86) PCT No.: PCT/EP2015/053256

§ 371 Date: Aug. 16, 2016

(30) Foreign Application Priority Data
Feb. 17, 2014 (AT) A 50117/2014

(51) Int. Cl. C02F 1/18; B01D 1/00; B01D 1/30; C02F 1/14

(52) U.S. Cl. CPC C02F 1/18; C02F 1/14; B01D 1/0035; B01D 1/30; C02F 2201/004; C02F 2307/02

(57) ABSTRACT

The invention relates to an adapter (10′) for connecting at least two plastic bottles (A, B), preferably PET bottles, the screw connections (2) of which are screwable into corresponding threaded receptacles (11, 12) of the adapter (10′). In order to produce a compact water purifying or water treatment system, a first flow path (D) is formed in the adapter (10′), which flow path establishes a flow connection for water vapour from a first threaded receptacle (11) to a second threaded receptacle (12), wherein a plastic bottle (A) filled at least partly with waste water is insertable into the first threaded receptacle (11) and an empty plastic bottle (B) is insertable into the second threaded receptacle (12), wherein a second flow path (K) for collecting and discharging condensed water out of the empty plastic bottle (B) is formed in the adapter (10′).

The invention relates to an adapter for connecting at least two plastic bottles, preferably PET bottles, the screw connections of which are screwable into corresponding threaded receptacles of the adapter, as well as a packaging unit which comprises several plastic bottles, preferably PET bottles filled with water or the like, as well as an adapter for connecting at least two of the plastic bottles to form a water purifying or water treatment system.

Apparatuses and auxiliary means are required for purifying contaminated water for the purpose of supply and provision in disaster areas such as earthquake areas and in areas with a critical supply of drinking water, e.g. in order to produce drinking water from waste water or fresh water from salt water. Waste water shall be understood below as contaminated water, rainwater and also salt water.

DE 198 15 541 C1 describes in this context a transportable distilling device which is formed as a film tunnel consisting of a semicylindrical top film and a flat bottom film. Tubular pressure chambers are formed between the top film and the flat bottom film on both sides, which pressure chambers are formed integrally with the top film. The storage area for seawater is spatially separated by the pressure chambers from the upper evaporation area, and the entire apparatus, which is sealed at the front and the rear by semicircular wall sections, is mechanically stabilised. The evaporation and condensation chamber, through the transparent surface of which the sunlight can penetrate, is subjected to an overpressure. During the operation of the distillation device, the water situated in the storage area is evaporated by the thermal action from the outside. The water vapour thus produced rises up and is condensed on the top film, wherein the condensate flows off to the left and right and is collected in a condensation area which is formed between the top film and the tubular pressure chambers. The fresh water can be taken from these areas via a drain.

A floating distilling apparatus is further known from GB 832 123, which comprises a transparent outer shell which is folded by a network of inflatable support tubes. The formed distillate is collected in an annular chamber in the bottom region of the apparatus and can be removed by a hose.

A portable, solar thermal apparatus for water treatment is known from AT 509 172 A1, which consists of the following parts:
a bottom vessel with a cylindrical connecting region which accommodates the contaminated water;
an upper vessel forming the condensation region with a cylindrical connecting region, and
a support ring with a first and a second receiving flange for fastening the cylindrical connecting regions of the bottom vessel on the one hand and the upper vessel on the other hand, wherein the support ring comprises the collecting groove provided with a discharge line and a feed line for the contaminated water.

The support ring consists of an injection-moulded plastic part for example, in which hoses or tubes for the feed line and the discharge line are fastened in respective boreholes, preferably glued into said holes. The bottom vessel and the top vessel of the apparatus can be made of the two parts of a water bottle (e.g. a conventional three-litre, five-litre or eight-litre drinking water bottle) which is cut open in the bottom third and which after cutting merely need to be fastened to the two receiving flanges of the support ring, for which purpose an adhesive strip can be used. The original shape of a bottle can now be recognised again, wherein the inserted support ring with the inner collecting groove is now only situated in the bottom third. Only a certain amount of effort in the production of the water treatment system is disadvantageous.

It is the object of the invention to provide means with which a compact, solar thermal apparatus for obtaining fresh water or for water treatment can be produced in the simplest possible way when required. Furthermore, the apparatus shall offer rapid readiness for deployment and shall be stored, offered and maintained as compact as possible.

This object is achieved in accordance with the invention by an adapter which is used for the connection of at least two plastic bottles, preferably conventional PET bottles, whose screw connections can be screwed into respective threaded receptacles of the adapter, wherein a first flow path is formed in the adapter, which flow path establishes a flow connection for water vapour from a first threaded receptacle to a second threaded receptacle, wherein a plastic bottle filled at least partly with waste water is insertable into the first threaded receptacle and an empty plastic bottle is insertable into the second threaded receptacle, and a second flow path for collecting and discharging condensed water out of the empty plastic bottle is formed in the adapter.

According to a first simple embodiment of the invention, the adapter is formed in a substantially tubular manner and comprises respective threaded receptacles at opposite ends whose axes coincide. The adapter, which is made of plastic for example, connects a bottom bottle filled with waste water to an empty bottle which is turned upside down and in which the water vapour condenses which rises from the bottom bottle under solar irradiation. The condensate is discharged from the adapter.

According to an advantageous second embodiment of the invention, the adapter is formed in a curved or angled manner and respectively comprises threaded receptacles at opposite ends whose axes enclose an obtuse angle in the range of 110° to 160°, preferably in the range of 120° to 150°. With a respective support structure, a position for solar irradiation which is beneficial to water treatment can be produced.

A third embodiment of the invention provides that the adapter comprises a third and fourth threaded receptacle (i.e. a total of four threaded receptacles), wherein a further plastic bottle which is at least partly filled with waste water can be inserted into the third threaded receptacle and an empty plastic bottle can be inserted into the fourth threaded receptacle for receiving the water condensed in the empty plastic bottle. The yield of the water treatment system and its stability can be improved with this embodiment.

It is a special advantage to add the adapter in accordance with the invention to a set of beverage or water bottles in a blister package for example, and to offer a packaging unit which contains several filled plastic bottles and an adapter in accordance with the invention which is suitable when necessary for connecting at least two of the plastic bottles to a water purifying or water treatment system. Once the content of the beverage or water bottles is used up, the bottles can be used by means of the adapter within the terms of the invention.

The invention will be explained below in closer detail by reference to the illustrations of exemplary embodiments, wherein:

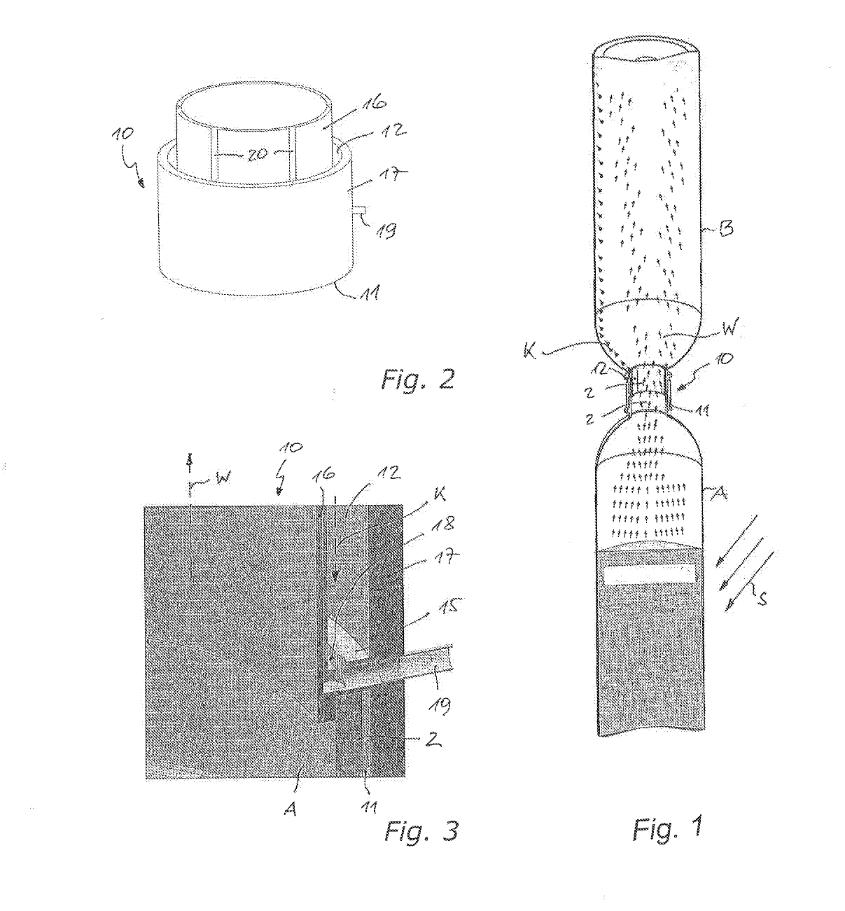

FIG. 1 shows a solar thermal apparatus for water treatment by using a first variant of an adapter in accordance with the invention in a sectional view;

FIG. 2 shows the adapter in accordance with the invention according to FIG. 1 in a three-dimensional view;

FIG. 3 shows a partly sectional view of the adapter in accordance with the invention according to FIG. 1;

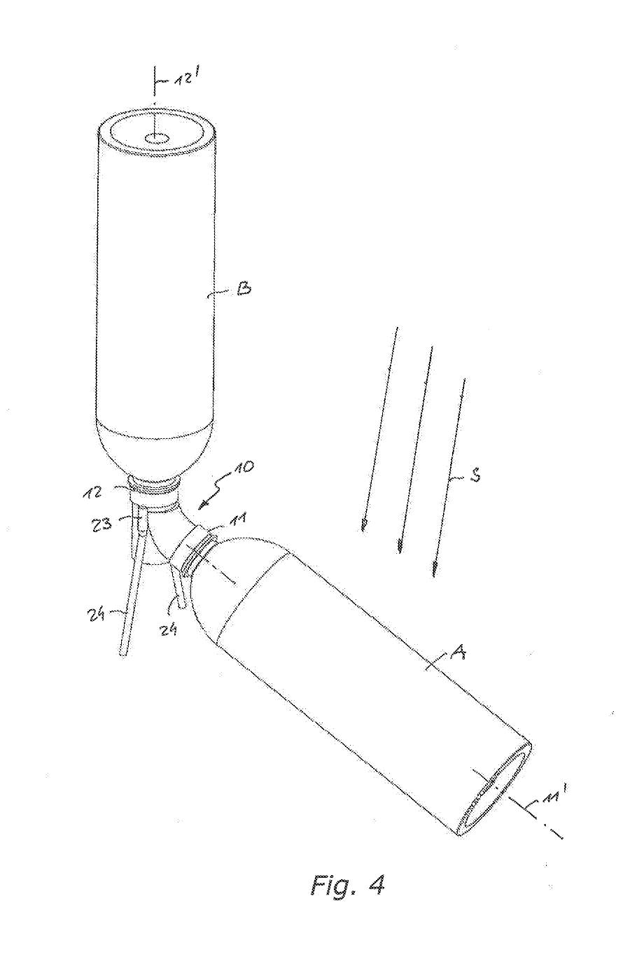

FIG. 4 shows a solar thermal apparatus for water treatment by using a second variant of an adapter in accordance with the invention in a three-dimensional view;

FIG. 5 shows the adapter in accordance with the invention according to FIG. 4 in a sectional view;

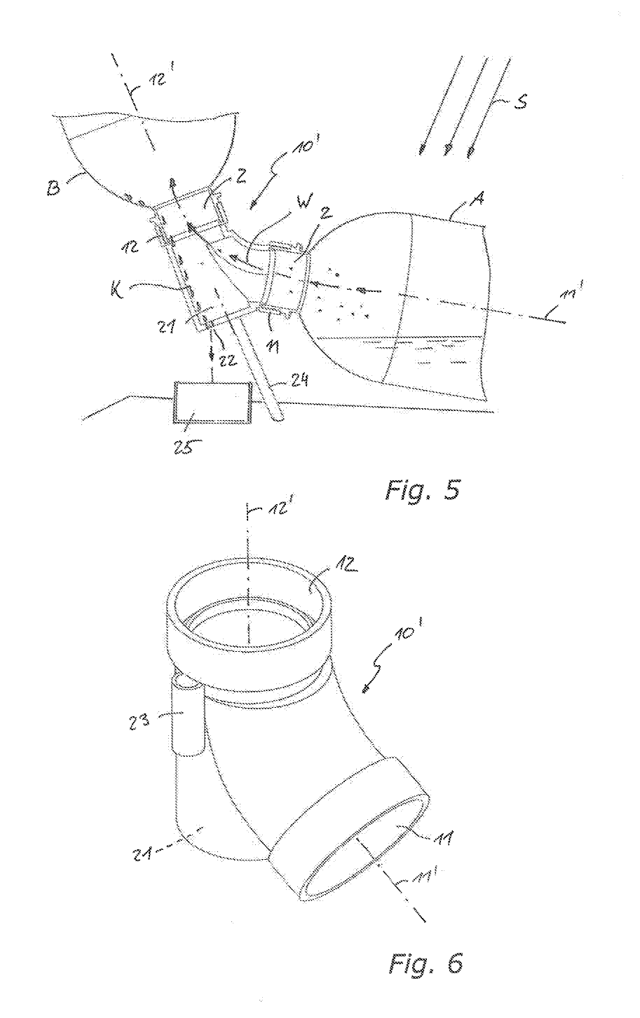

FIG. 6 shows the adapter in accordance with the invention according to FIG. 4 in a three-dimensional view;

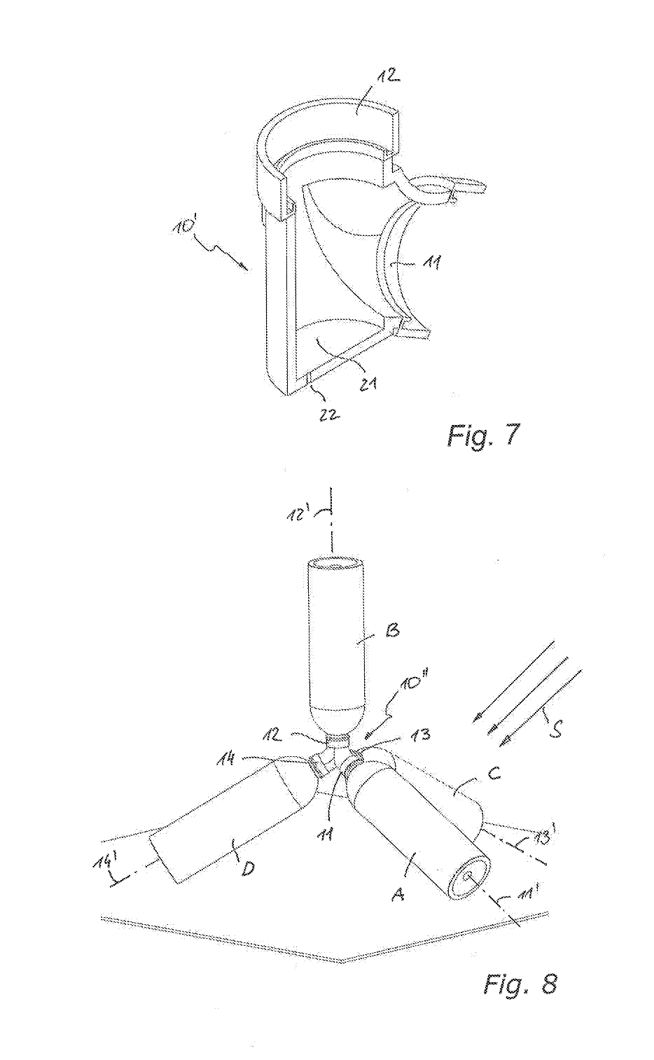

FIG. 7 shows a partly sectional view of the adapter in accordance with the invention according to FIG. 4;

FIG. 8 shows a solar thermal apparatus for water treatment by using a third variant of an adapter in accordance with the invention in a three-dimensional view, and

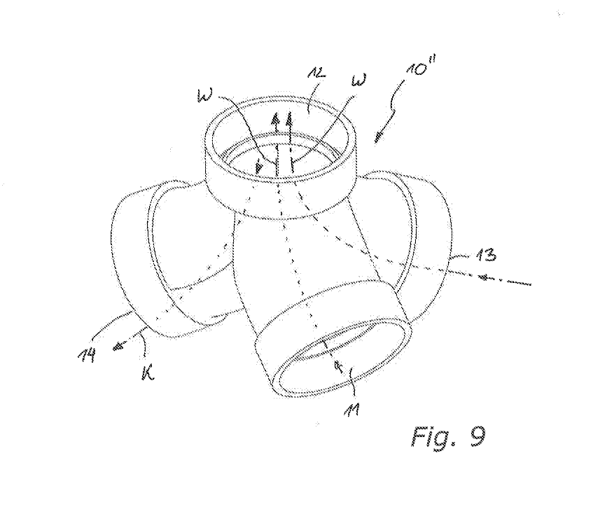

FIG. 9 shows the adapter in accordance with the invention according to FIG. 4 in a three-dimensional view.

### Variant 1

The embodiment of a solar thermal apparatus shown in FIGS. 1 to 3 substantially consists of three parts, namely of the two PET bottles A and B, which can be assembled by means of the adapter 10 via their screw connections 2 into a water treatment device. The bottom bottle A is used as a container in which the waste water is heated by sunlight S, evaporated and then rises upwardly through the central opening of the adapter 10. The upper bottle B is used for condensation. The evaporated water thus condenses on the inner surface of the upper bottle and forms droplets which then run downwardly into the bottleneck for collection in the adapter.

The adapter 10 is formed in a substantially tubular manner and respectively comprises threaded receptacles 11, 12 at opposite ends, with the axes of said receptacles coinciding. The entire opening cross-section of the adapter 10 is available as the flow path W for the rising water vapour. The flow path K for the condensate commences on the inner wall of the bottle A and is formed in the adapter 10 for collecting and discharging condensed water.

The adapter 10 comprises an annular shoulder 15 in the interior, on which rest the plastic bottles A, B which are inserted into the adapter, wherein a cylindrical collar 16 is integrally formed on the annular shoulder 15, which collar forms an annularly extending collecting groove 18 for the condensate together with the cylindrical outer wall 17 of the adapter 10 (see FIG. 3). The collecting groove 18 is flow-connected to an outwardly leading connecting line 19 where the clean drinking water is collected, e.g. in a bag (not shown).

The cylindrical collar 16 comprises discharge grooves 20 in its surface (see FIG. 2), which lead into the annular collecting groove 18 and discharge the condensate from the collar region of the bottle B.

### Variant 2

The adapter 10′ according to variant 2, which is shown in FIGS. 4 to 7, is formed in a curved or angled manner and respectively comprises threaded receptacles 11, 12 at the ends, whose axes 11′, 12′ enclose an obtuse angle in the range of 110° to 160°, preferably in the range of 120° to 150°. The adapter 10′ comprises a collecting chamber 21 opposite the second threaded receptacle 12 for receiving the water condensed in the empty plastic bottle B, wherein a discharge opening 22 is provided in the bottom of the collecting chamber 21 from which the produced drinking water discharges into a collecting vessel 25. It is also possible to connect an unfolding film bag (not shown in closer detail) via a hose line to the discharge opening 22, which bag receives the produced drinking water.

Variant 2 shall ensure a greater and more efficient energy yield of the sunlight. The adapter 10′ was angled for this purpose. If the waste water bottle A and the condensation bottle B are screwed together with the adapter 10′, the two bottles A, B are disposed at an angle of 130° with respect to each other for example.

At least one receiver 23 for a supporting device such as supporting rods 24 is integrally formed in accordance with the invention on the outside wall of the adapter 10′, with which supporting device the adapter 10′ plus the inserted plastic bottles A, B can be oriented in a position in relation to the solar irradiation S which is beneficial to water treatment (see FIGS. 4 and 5).

The oblique position of the waste water bottle A increases the evaporation surface of the waste water and improves the angle of incidence of the sunlight S. The oblique position of the condensation bottle B ensures that the condensed water accumulates in the rear bottom part of the adapter 10′ in the collecting chamber 21 and the system can thus also make do without the collecting groove in the adapter.

### Variant 3

In variant 3, the adapter 10″ comprises a third 13 and a fourth threaded receptacle 14, wherein a further plastic bottle C which is filled at least partly with waste water can be inserted into the third threaded receptacle 13 and an empty plastic bottle D for accommodating the water condensed in the plastic bottle B can be inserted into the fourth threaded receptacle 14.

The axes 11′, 13′ of the first and the third threaded receptacle 11, 13 for accommodating the plastic bottles A, C which are filled at least partly with waste water, together with the axis 14′ of the fourth threaded receptacle 14 for accommodating the condensed water, are oriented in accordance with the invention in such a way that after the insertion of the plastic bottles A, C, D a stable tripod is obtained and at the same time the bottles A, C which are filled with waste water are oriented in a position in relation to the solar irradiation S which is beneficial for water treatment.

Variant 3 thus represents an improvement over variant 2 in which it additionally comprises a second waste water bottle C. This produces a doubling of the evaporation surface. Furthermore, an empty bottle D is screwed onto the fourth threaded receptacle 14 of the adapter 10″ and is used as a collecting container for the purified water. There is a further advantage in that no supports are required as a result of the tripod structure of the apparatus.

It is advantageous if the axis 12′ of the second threaded receptacle 12 is oriented perpendicularly or in a slightly inclined manner in the direction of the empty plastic bottle D (approximately 5° to 15°) in the operating position for accommodating the condenser plastic bottle B. As a result of the slight inclination, the purified water preferably flows in the direction of the plastic bottle D.

The slight inclination of the plastic bottle B in the direction of the collecting bottle D can also be achieved by partly burying the bottle D or by a base (rocks, board, etc) for the bottles A and C.

The adapters 10, 10′ and 10″ are preferably part of a packaging and sales unit of PET bottles which are filled with water or the like.

In an embodiment according to FIGS. 4 to 7, the packaging unit also contains a supporting device such as supporting rods 24, with which supporting device the adapter 10′ plus the inserted plastic bottles A, B can be oriented in a position in relation to solar irradiation S which is beneficial for water treatment.

Furthermore, the packaging unit can contain means in order to further increase the evaporation rate in the bottles A, C which are filled with waste water and to improve the condensation performance of the condenser bottle B. These are a black cover (e.g. hose-shaped) or a black paint coating for the bottles A, C and/or a white cover, a white paint coating or shading means for the condenser bottle B. It is also possible to tone the waste water with a dark colour, e.g. by adding potassium permanganate.

1. An adapter for connecting at least two plastic bottles, preferably PET bottles, the screw connections of which are screwable into corresponding threaded receptacles of the adapter, wherein a first flow path (W) is formed in the adapter, which flow path establishes a flow connection for water vapour from a first threaded receptacle to a second threaded receptacle, wherein a plastic bottle (A) filled at least partly with waste water is insertable into the first threaded receptacle and an empty plastic bottle (B) is insertable into the second threaded receptacle, and a second flow path (K) for collecting and discharging condensed water out of the empty plastic bottle (B) is formed in the adapter.

2. The adapter according to claim 1, wherein the adapter is formed in a substantially tubular manner and comprises respective threaded receptacles at opposite ends whose axes coincide.

3. The adapter according to claim 2, wherein the adapter comprises an annular shoulder in the interior, on which rest the plastic bottles (A, B) which are inserted into the adapter, wherein a cylindrical collar is integrally formed on the annular shoulder, which collar forms an annularly extending collecting groove for the condensate together with the cylindrical outer wall of the adapter, which collecting groove is in the flow connection with a connecting line which leads to the outside.

4. The adapter according to claim 3, wherein the cylindrical collar comprises discharge grooves in its surface, which lead to the annular collecting groove.

5. The adapter according to claim 1, wherein the adapter is formed in a curved or angled manner and respectively comprises threaded receptacles at opposite ends whose axes enclose an obtuse angle in the range of 110° to 160°, preferably in the range of 120° to 150°.

6. The adapter according to claim 5, wherein the adapter comprises a collecting chamber opposite the second threaded receptacle for receiving the water condensed in the empty plastic bottle (B), wherein a discharge opening is provided in the bottom of the collecting chamber.

7. The adapter according to claim 5, wherein at least one receiver for a supporting device such as supporting rods is integrally formed on the outer wall of the adapter, with which supporting device the adapter plus the inserted plastic bottles (A, B) can be oriented in a position in relation to solar irradiation (S) which is beneficial for water treatment.

8. The adapter according to claim 1, wherein the adapter comprises a third and fourth threaded receptacle, wherein a further plastic bottle (C) which is at least partly filled with waste water can be inserted into the third threaded receptacle and an empty plastic bottle (D) can be inserted into the fourth threaded receptacle for receiving the water condensed in the empty plastic bottle (B).

9. The adapter according to claim 8, wherein the axes of the first and the third threaded receptacle for accommodating the plastic bottles (A, C) which are filled at least partly with waste water, together with the axis of the fourth threaded receptacle for accommodating the condensed water, are oriented in such a way that after the insertion of the plastic bottles (A, C, D) a stable tripod structure is obtained.

10. The adapter according to claim 8, wherein the axis of the second threaded receptacle for accommodating the condenser plastic bottle (B) is oriented perpendicularly or slightly in an inclined manner in the direction of the empty plastic bottle (D) for accommodating the condensed water.

11. The packaging unit, which comprises several plastic bottles (A, B, C, D), preferably PET bottles filled with water or the like, and an adapter according to claim 1, which is used for connecting at least two of the plastic bottles (A, B, C, D) to form a water purifying or water treatment system.

12. The packaging unit according to claim 11, wherein the packaging unit comprises a supporting device such as supporting rods, with which supporting device the adapter plus the inserted plastic bottles (A, B) can be oriented in a position in relation to solar irradiation (S) which is beneficial for water treatment.
